(19) United States
(12) Patent Application Publication
(10) Pub. No.: US 2017/0158088 A1
(43) Pub. Date: Jun. 8, 2017

(54) SEAT CONTOUR CONTROL SYSTEM AND METHOD

(71) Applicant: Adient Luxembourg Holding S.á.r.l., Luxembourg (LU)

(72) Inventors: Mason PIKE, Howell, MI (US); Patrick CREAMER, Pittsburgh, PA (US)

(21) Appl. No.: 15/366,348

(22) Filed: Dec. 1, 2016

Related U.S. Application Data
(60) Provisional application No. 62/263,158, filed on Dec. 4, 2015.

(51) Int. Cl. B60N 2/02; B60N 2/64; B60N 2/44

(52) U.S. Cl. CPC B60N 2/0244; B60N 2/4415; B60N 2/0232; B60N 2/646; B60N 2/0228; B60N 2002/0268

(57) ABSTRACT

A seat with an adjusting mechanism for selectively changing a contour and firmness of the seat. A force/pressure sensor is arranged between the contour of the seat which is in contact with the occupant, and the adjusting mechanism. The force/pressure sensor measures the actual force/pressure with which the occupant presses upon the seat, and which force/pressure is adjustable by the respective adjusting mechanism. A control unit stores a desired force/pressure value for the seat, and controls the adjusting mechanism to drive the actual force/pressure towards the desired force/pressure. The seat also has an operator interface which receives input from an operator. The control unit has a manual mode where the adjusting mechanism is only controlled by the operator interface. The control unit in the automatic mode records the actual value from the force/pressure sensor when the operator adjusts the seat through the interface. The control unit then sets the desired force/pressure to the present value of the force/pressure sensor. Once the operator is finished changing the adjusting mechanism, the control unit continues in automatic mode and performs any changes to the adjusting mechanism to drive the actual force/pressure from the force/pressure sensor for the value of the new desired force/pressure.

### CROSS REFERENCE TO RELATED APPLICATIONS

This application claims the benefit of priority under 35 U.S.C. §119 of U.S. provisional application 62/263,158, filed on Dec. 4, 2015, the entire contents of which are incorporated herein by reference.

### FIELD OF THE INVENTION

The present invention relates to controlling the contour of a seat, and in particular to adjusting the shape and firmness of the seat contour that is in contact with the occupant of the seat.

### BACKGROUND OF THE INVENTION

The optimum shape/contour and firmness of a seat depends on many different conditions. Some of those conditions are the shape of the occupant of the seat, the position of the occupant in the seat, and the conditions under which the occupant sits in the seat. It is often desirable to have the shape/contour of the seat, as well as the firmness of the seat, to be adjustable in order to optimize the comfort of different occupants, and under the different conditions. The more portions of the seat that are adjustable, the more optimum a seat can be configured for the occupant.

Automobile seats especially benefit from being adjustable. Automobiles are used by occupants of many different sizes, having many different preferences in a seat, and the conditions under which an occupant sits in the seat, often changes, especially depending on road conditions driving conditions. It is difficult, and often inconvenient, to change the seats in an automobile for each occupant. Therefore the more adjustable and automobile seat is, the more desirable the automobile is to possible customers.

The shape and firmness of seats, especially automobile seats, can be adjustable in many different ways. One way of adjusting seats, is with a pneumatic bladder system where the seat contains a bladder, or a plurality of bladders, that are inflated and deflated to adjust the shape and firmness of different portions of the seat. Other ways of adjusting the portions of the seat, can be with a plate, or plates, with linkage positioned in the cushion of the seat, where the position of the plates is selectively adjustable. A cable, or cables, with selectively adjustable tension, as well as a selectively adjustable spring, or springs, are some of the many other ways that the shape and firmness of the seat can be adjusted. The cables and/or springs can be adjusted by electric actuators, such as electric motors which can wind or unwind the cables and or springs. The cables and/or springs can also be adjusted by an electric solenoid which can change the length of the cables and/or springs to adjust the tension in the cables and/or springs. The winding up or tensioning the cables and/or springs can increase the firmness of the respective seat portions, while the unwinding or releasing tension in the cables and/or springs can decrease the firmness of the respective seat portions. The present invention can be used with many different mechanisms for adjusting the shape and firmness of a seat, and is not limited to just those mechanisms described.

Currently, automotive pneumatic bladder systems are manually adjustable by the occupant. These systems only allow for one pneumatic bladder, or a set of pneumatic bladders at a time to be controlled by the occupant via a pump and valve controller to inflate, deflate or maintain pressure in the bladder(s). As the number of bladders in seats increases, the complexity of adjustment does as well for the occupant. Currently it is necessary to adjust all bladders, or sets of bladders, individually to achieve a desirable pressure distribution amongst all bladders for optimized comfort.

Prior automotive seat pneumatic bladder systems have had closed-loop feedback control based on pressure sensing before. Usually the pressure being measured is internal to the bladder, or bladder set via single pressure sensor. The bladder, or bladder set, is connected by a valve controller to a pneumatic line. The pressure sensor is usually inside the valve controller and measures the pressure of the gas inside the bladder. Such valve controllers with gas pressure sensors are relatively complex and expensive.

In systems such as U.S. Pat. No. 6,422,087, only a single pressure sensor is used which connects to the individual plurality of pneumatic bladders through a manifold. This reduces the cost by only having a single pressure sensor for measuring gas pressure. A disadvantage, is that only one of the bladders can be adjusted at a time. The manifold has to connect a single bladder to the gas pressure sensor, and then the gas pressure in that one bladder has to be adjusted until an actual gas pressure in the bladder matches a desired gas pressure. Only after this is finished, can the next bladder be measured and adjusted. The time to adjust each bladder depends on the size of the pump, the size of the plumbing, and the size of the specific bladder. A high capacity pump, and high-capacity plumbing, can reduce the adjustment time. However such structures are expensive, large, and heavy relative to lower capacity pumps and plumbing. Therefore low capacity pumps and plumbing are often use, which increases the adjustment time. An occupant of a seat may have to wait for a relatively long time as each of as many as 10 bladders are sequentially adjusted. If each bladder requires a second or two of adjustment, the time taken to adjust all the bladders of the seat can be burdensome for the occupant.

U.S. Pat. Nos. 6,088,643 and 6,098,000 describe a system with a single pressure sensor 139 in FIG. 8, or a system with a plurality of pressure sensors 116 in FIG. 7. The system shown in FIG. 7 of these two US patents, requires a plurality of sensors which can increase the cost, size and weight of the system. The system shown in FIG. 8 of these two US patents uses only a singles pressure sensor 139, but then require sequential measuring and a subsequent sequential adjusting of each individual zone. The system shown in FIG. 8, also have sense cells 140. These appeared to detect changes in the shape of the air cells. The shape of the air cells only appears to be used to detect a seat pattern such as produced by packages and the like, and if the signal pattern differs from an acceptable signature, a signal is generated instructing the bladders of these two patents to deflate.

### SUMMARY OF THE INVENTION

The present invention addresses the difficulty of adjusting the shape and firmness of portions of a seat with an adjusting mechanism, or many adjusting mechanisms, for selectively changing the contour and firmness of the respective portions of the seat. A force/pressure sensor is arranged between the outer contour of the seat which is, or will be, in contact with the occupant, and the firmness adjusting mechanism. The force/pressure sensor measures a force/pressure with which the occupant presses upon a portion of the seat, and the respective adjusting mechanism for that portion is operated to adjustable that pressure. The force/pressure sensor is not arranged inside the bladder, and does not measure the gas pressure inside the bladder. Such force/pressure sensors are often less expensive than gas pressure sensors, and can use technology to measure forces that would not be applicable, would be impractical when used to try to measured gas pressure. Furthermore, the force between the outer contour of the seat and the adjusting mechanism is a more straightforward relationship, so that it is easier to measure with alternate technology than the gas pressure inside a bladder.

Instead the force/pressure sensor would be between the bladder and the outer contour of the seat if the adjusting mechanism was a pneumatic/fluid type system. The force/pressure sensor instead of measuring the gas pressure inside a bladder, instead measures the amount of force that the occupant is pressing/applying to the sensor, and that particular portion of the seat. For example, the force/pressure sensor would measure the amount of newtons in the SI measurement system, that the occupant is applying to the sensor.

A control unit receives the actual force/pressure value from the force/pressure sensor, and the control unit also stores a desired force/pressure value for the respective portion of the seat. The control unit also controls the adjusting mechanism to drive the actual force/pressure towards the desired force/pressure.

The present invention also has an operator interface which receives input from an operator, usually the occupant of the seat. The control unit and adjusting mechanism(s) are controlled from the operator interface. The operator can place the control unit in manual mode, where the adjusting mechanism(s) is(are) only controlled by the operator interface. In the manual mode, the operator adjusts selectively chooses how to adjust each adjusting mechanism. For example, the occupant sits in the seat and operates the operator interface to select one of the adjusting mechanisms, and then changes parameters on the adjusting mechanism until the respective portion of the seat is in a desirable condition.

The operator can also place the control unit in an automatic mode where the control unit controls the adjusting mechanism to drive the actual force/pressure measured towards the desired force/pressure as described above, and which has been predetermined. In the automatic mode, the operator can also selectively vary parameters of the adjusting mechanism. If the parameters of an adjusting mechanism is changed by the operator during the automatic mode, the control unit can record the actual value from the force/pressure sensor. The control unit can then set the desired force/pressure to the present value of the force/pressure sensor. Once the operator is finished changing the parameters of adjusting mechanism, the control unit continues in automatic mode and performs any changes to the adjusting mechanism to drive the actual force/pressure from the force/pressure sensor to the value of the new desired force/pressure.

When the control unit is switched from manual mode to automatic mode, the control unit can optionally and selectively use the measurements of the force/pressure sensors as the desired values for the force/pressure in the automatic mode.

To reduce a complexity of adjustment for occupants using automotive pneumatic bladder comfort systems, the feedback system/control unit is utilized for closed-loop control of individual pneumatic bladders and sets of pneumatic bladders. (A set of pneumatic bladders is defined as any pneumatic bladders that share the same pneumatic input to a pneumatic valve controller). The closed-loop feedback system will serve to automatically adjust pressure levels amongst all pneumatic bladders. The closed-loop feedback system will detect forces/pressures on the surface of the pneumatic bladders due to the occupant's weight by piezoresistive force/pressure sensors. These sensors are adhered or otherwise integrated directly into or onto the outer surface of the pneumatic bladder(s). Depending on the force/pressure exerted on the surface of the bladder, the resistance of the piezoresistive force/pressure sensors will decrease as force increases, this serves to increase the voltage drop across the piezoresistive sensor. The voltage is then detected by the control unit, which reads an input voltage which correlates directly to a force/pressure on the surface of a bladder.

The force/pressure exerted on the sensor and the surface of the bladder will change based on the materials between the bladder surface and the occupant. This can be addressed by tuning/calibrating any given automotive seat and control unit to correlate these voltage levels to correspondingly comfortable force/pressure levels.

The control unit is preferably connected to a pump and a pneumatic valve controller. Depending on the voltage level and corresponding force/pressure levels detected by the piezoresistive sensor on the outer surface of a pneumatic bladder, the control unit will send signals to the pump and valve controller to accordingly inflate, deflate or maintain pressures in the pneumatic bladder the piezoresistive sensor is adhered to. The control logic will continuously loop to check force/pressure readings on all sensors of the bladders and move/drive toward a particular force/pressure target on each sensor on each bladder or set of bladders (and corresponding voltage inputs) either set previously as part of the controller's code, or by the occupant adjusting the set point to their preferred force/pressure target by manual inputs into the control unit through the operator interface. The controller logic is preferably applied to all bladders simultaneously such that each sensor for a bladder has its force/pressure level adjusted simultaneously rather than sequentially updating each bladder individually.

The system's automatic force/pressure adjustment function can be enabled or disabled by user input. When the system is on, the controller will seek to adjust all bladders in the seat so that their sensors are at the desired/target force/pressure values. When the system is disabled the current force/pressure will be maintained at the time it is disabled. The user can then manually control all bladders or bladder sets to fine tune force/pressure levels to their liking. This value that they adjust to in manual mode can be recorded, and can be used as the new set point to adjust to the next time the automatic adjustment mode is enabled.

The automatic adjustment mode enables the surface seat contour generated by the force/pressure exuded on the occupant by pneumatic bladders to be continuously updated according to dynamic driving conditions (road input) and variation in an occupant's posture.

The invention as described is not limited exclusively to piezoresistive sensing methods. Pressure sensing can also be achieved via resistive, capacitive or inductive means. Also the mechanism or method to adjust the seat contour/firmness is not limited to pneumatic bladders, but also can be achieved by mechatronic systems that involve motor control and a mechanical linkage to change a seat's contour.

The pressure measured by the present invention is measured on an exterior of the adjusting mechanism and is not a pressure being measured internal to the bladder or bladder set by a sensor such as inside a valve controller of which the bladder, or bladder set, is connected to via a pneumatic line. By using an external force/pressure sensor on a bladder and a microcontroller, closed-loop feedback control can be implemented on current automotive bladder systems without modifying the current automotive bladder systems directly, and does not require a more complex pressure sensing valve controller. This system also allows occupants to change the targeted pressures of the automatic adjustment mode to their liking.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a view of a portion of seat of the present invention;

FIG. 2 is a view of a pressure sensor;

FIG. 3 is a cross sectional schematic view of a portion of the seat of the present invention with bladders as adjusting mechanisms;

FIG. 4 is a flowchart showing the steps for adjusting the seat in the automatic mode;

FIG. 5 is a continuation of the flowchart of FIG. 4;

FIG. 6 is an example of the pneumatic connections and wiring diagram of the present invention; and

FIG. 7 is a cross sectional schematic view of a portion of the seat of the present invention with cables and/or springs as adjusting mechanisms.

### DESCRIPTION OF THE PREFERRED EMBODIMENTS

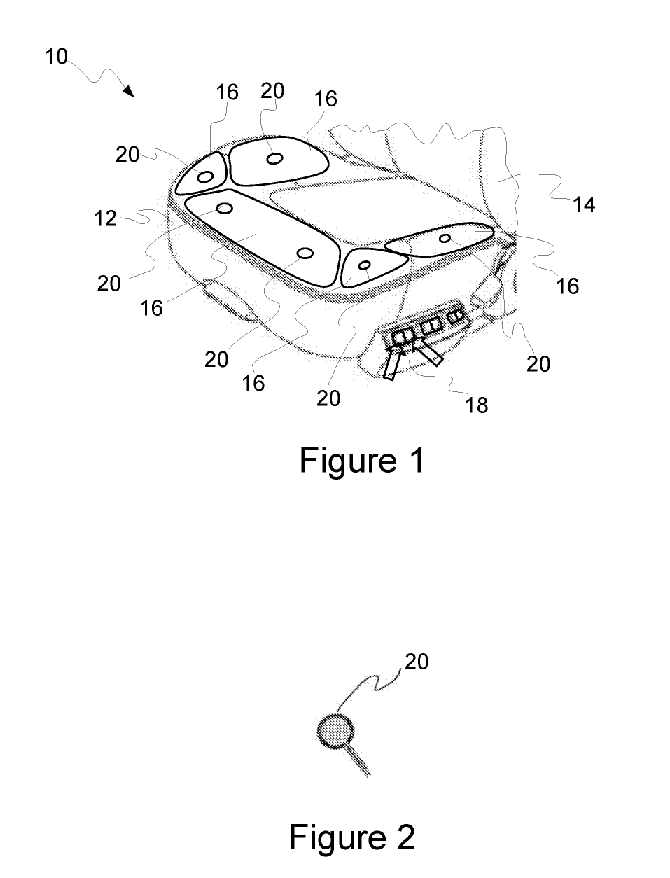

Referring to the drawings in particular, FIG. 1 shows a seat 10 which has a seat base 12 and a seat back 14. In the seat base 12 is shown a plurality of adjusting mechanisms 16. The adjusting mechanisms 16 change the shape/contour of a portion of the seat, as well as the firmness of that portion of the seat. The adjusting mechanisms 16 can include pneumatic bladders that are selectively inflatable and deflatable. A single adjusting mechanisms 16 can have one pneumatic bladder or a set of pneumatic bladders to adjust the contour and/or the firmness of the respective portion of the seat. FIG. 1 shows adjusting mechanisms 16 in the seat base 12. It is also possible for adjusting mechanisms 16 to be incorporated into the seat back 14, and any other portions of a seat 10 where the contour and/or firmness of that portion of the seat is desired to be adjustable.

In between the adjusting mechanism 16 and the occupant of the seat, there are pressure sensors 20. These pressure sensors 20 measure the pressure or force that the occupant places against the respective portion of the seat. The force that the occupant presses onto the seat portion and associated force/pressure sensor can be measured in newtons or any other force unit. While the force that the occupant presses on to the seat can be considered a pressure, that force/pressure is not necessarily the gas pressure inside a respective bladder. The force that the sensors 20 measure is a force that is in a different location than the force from the gas pressure in the respective bladder.

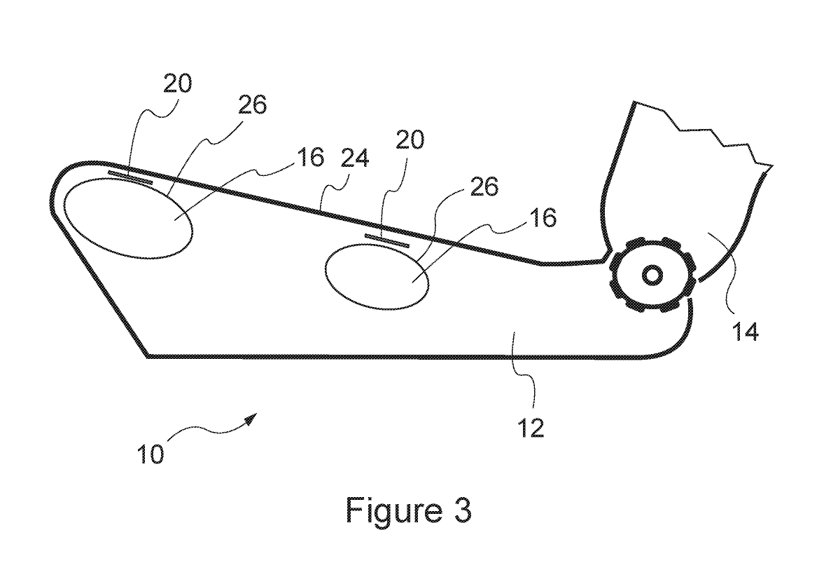

Each force/pressure sensor 20 is preferably associated with at least one of the adjusting mechanisms 16, and it is possible for more than one force/pressure sensor 20 to be associated with a single adjusting mechanism 16. The force/pressure sensors 20 can be placed on the exterior of the adjusting mechanisms 16. If the adjusting mechanisms 16 is a pneumatic bladder, the associated force/pressure sensor 20 can be placed between the outer surface 26 of the pneumatic bladder and the surface 24 of the associated portion of the seat, as shown in FIG. 3.

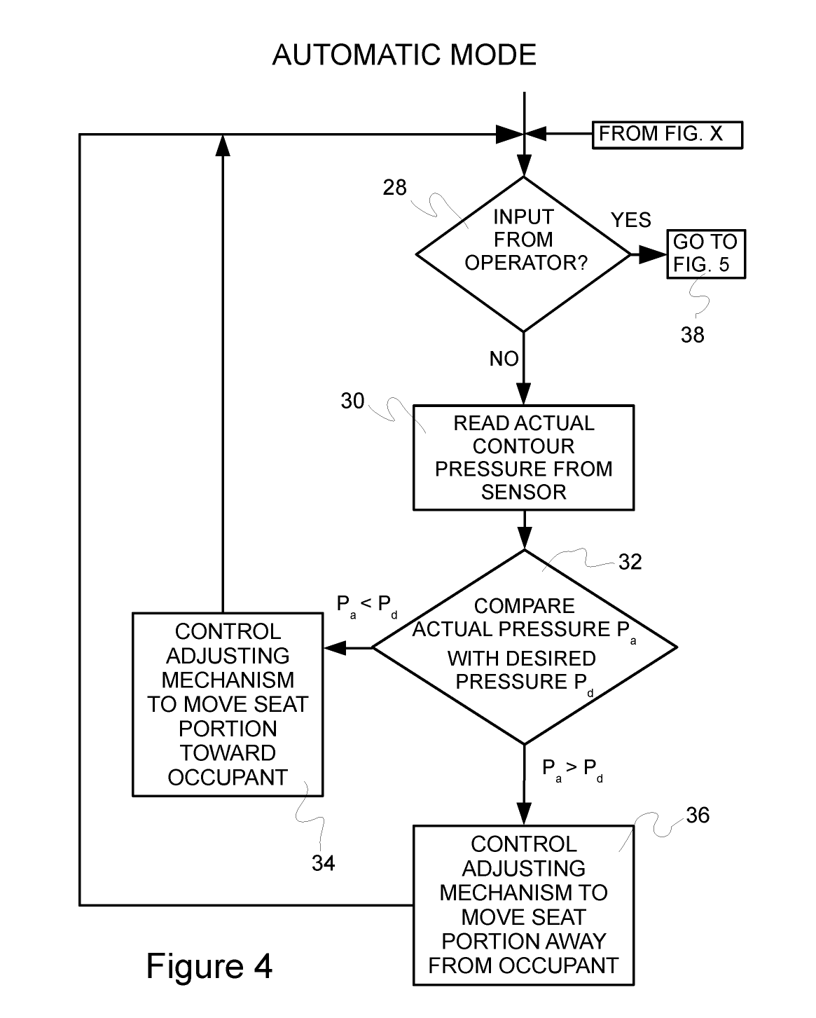

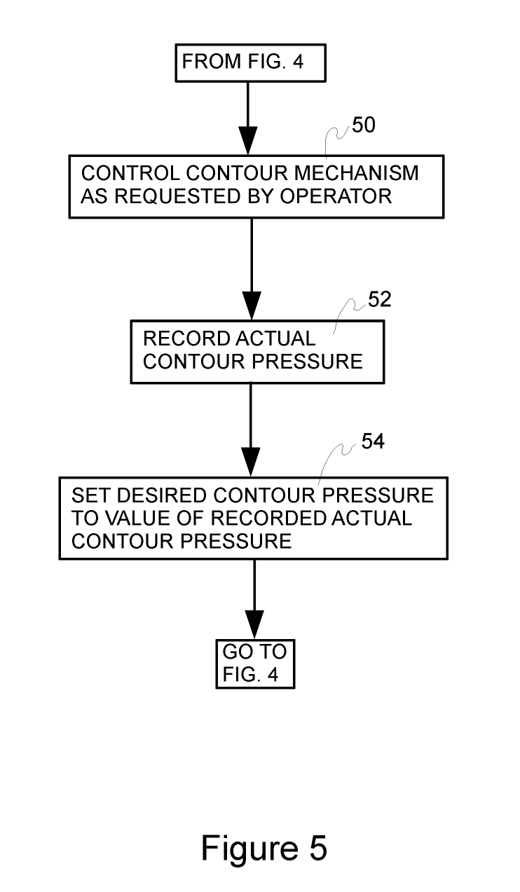

In one embodiment, as shown in FIG. 4, of the present invention, the actual contour force/pressure value Pa is read at step 30 from the force/pressure sensor 20. This actual contour force/pressure value Pa is compared 32 with a desired/target force/pressure value Pd that has been predetermined. If the actual contour force/pressure value Pa is less than the desired force/pressure value Pd then a control unit 40 in step 34 moves the adjusting mechanism 16 toward the occupant. If the actual contour force/pressure value Pa is greater than the desired force/pressure value Pd then a control unit 40 in step 36 moves the adjusting mechanism 16 away from the occupant. The present invention then returns back to step 30 to read the actual contour force/pressure value Pa from the force/pressure sensor 20, and the process starts over again.

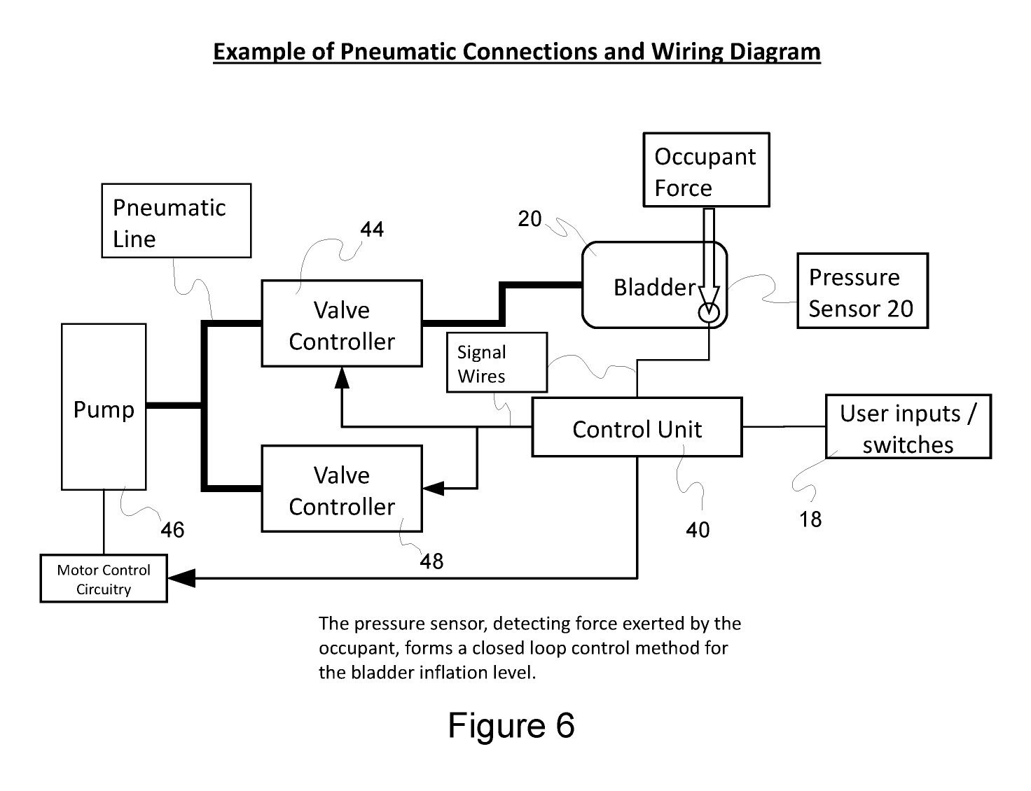

In the embodiment of FIG. 6, the adjusting mechanism 16 includes a pneumatic bladder 42, a valve controller 44 and a pump 46. The control unit 40 receives the actual contour force/pressure value Pa from the pressure sensor 20 over a signal line/wire. The control unit 40 moves the pneumatic bladder 42 by controlling the valve controller 44 and the pump 46 over the signal lines/wires. In particular, when the adjusting mechanism 16/bladder 42 is to move a portion of the seat 10 toward the occupant, or make that portion firmer, the pump is operated to supply gas via the pneumatic line to the valve controller 44, and the valve controller 44 is operated to use the gas from the pump 46 to inflate the bladder 42 in another pneumatic line. When it is desired to move the portion of the seat 10 away from the occupant, or to make that portion less firm, the pump 46 can stop operation if it is not needed for any other purposes, such as inflating other bladders, and the valve controller 44 is operated to discharge gas from the bladder 42.

Another valve controller 48 can also be controlled by the control unit 40 to control other pneumatic bladders for other portions of the seat 10. There could be even more valve controllers than 44 and 48 as shown in FIG. 6 which control many more pneumatic bladders, depending on the number of portions of the seat that are to be adjustable.

The present invention also has an operator interface 18 where the operator can adjust the shape and firmness of the portions of the seat that have adjusting mechanisms. The operator interface 18 is connected to the control unit 40. If there is no input from the operator, then the control unit operates as shown in FIG. 4 to control the adjusting mechanisms to make in the actual contour force/pressure similar to the desired contour force/pressure.

As shown in FIGS. 4 and 5, if the operator desires to change the shape or firmness of the portion of the seat, the operator indicates this on the operator interface 18, and this information is sent to the control unit 40 which then controls in step 50 the adjusting mechanism 16 accordingly. While, or after, the adjusting mechanism 16 is being controlled by the operator, the actual contour force/pressure measured by the force/pressure sensor 20 is being recorded 52. The desired contour pressure can then be set at step 54 to the value of this recorded actual contour force/pressure. The process then starts again from step 28 of checking for input from the operator, as shown back again in FIG. 4. If the operator continues to adjust the seat 10, then the process goes back to operating as per FIG. 5. If the operator is no longer adjusting the seat, then step 28 proceeds to step 30 and the control unit 40 controls the adjusting mechanism 16 to make the actual contour force/pressure from the force/pressure sensors 20 be similar to the desired contour force/pressure as recorded in step 52 of FIG. 5. In this way, the operator adjusts the shape and/or firmness of the respective portion of the seat 10 to a desired value, and then the control unit keeps that portion of the seat at the desired shape and/or firmness. If the occupant of the seat changes his/her position, or the driving conditions change, the shape and/or firmness of a portion of the seat may also change, which may change the force/pressure measured by the force/pressure sensor 20. In the automatic mode, the control unit 40 controls the adjusting mechanism to try to keep the actual force/pressure similar to the desired force/pressure so that the occupant feels that the respective portion of the seat always has a similar shape and/or firmness as last adjusted by the operator through the operator interface 18.

The force/pressure sensors 20 measure the force that the occupant applies to the surface 24 and that force is transmitted through the seat in the direction of the adjusting mechanism 16. The placement of the force/pressure sensor 20 between the surface 24 of the seat and the adjusting mechanism 16 is advantageous in that the force/pressure sensor at this location measures the force differently than a pressure sensor which measures gas pressure inside a pneumatic bladder. Also the size of the force/pressure sensor 20 can be smaller than an effective surface area of the adjusting mechanism 16, and therefore the force/pressure sensor 20 can measure more local and specific forces than a sensor which measures gas pressure inside a pneumatic bladder. The location and size of the force/pressure sensors 20 therefore allow more specific measuring of the force that an occupant applies to the seat, and adjustments to the size and firmness of portions of the seat is therefore also more specific.

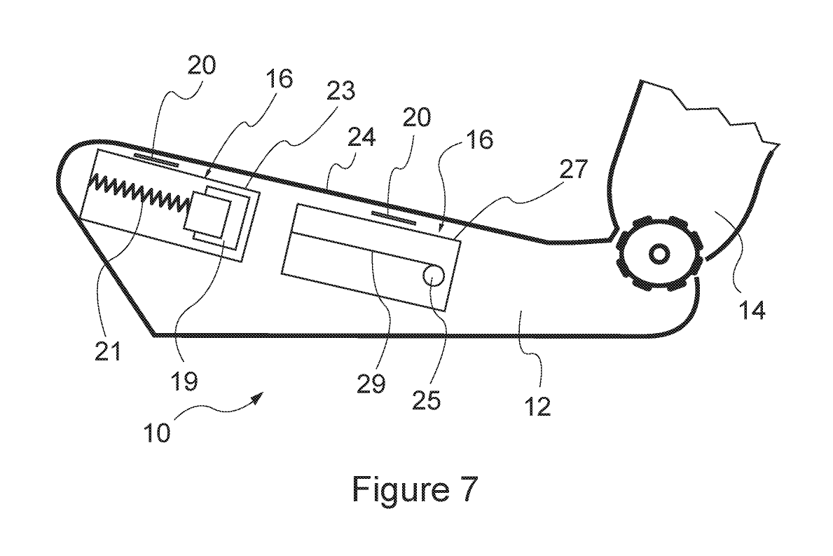

FIG. 7 shows an embodiment using a cable arrangement 27 for the adjusting mechanism 16. The cable arrangement 27 has a cable 29 and a motor 25. By rotating the motor 25, the cable 29 can be made tighter or looser which makes the corresponding portion of the seat firmer or softer. FIG. 7 also shows using a spring arrangement 23 for the adjusting mechanism 16. The spring arrangement 23 has a spring 21 and a solenoid 19 to adjust the tension in the spring 21. The solenoid 19 is connected to the spring 21, and a solenoid 19 has a mobile portion which can be selectively moved to adjust the length of the spring 21, which then controls how firm or soft is the corresponding portion of the seat.

While specific embodiments of the invention have been shown and described in detail to illustrate the application of the principles of the invention, it will be understood that the invention may be embodied otherwise without departing from such principles.

What is claimed is:

1. A seat comprising:
a cushion having a surface configured to support an occupant of the seat;
an adjusting mechanism arranged in said cushion, said adjusting mechanism selectively adjusting a contour and firmness of said surface;
a force sensor arranged on one of said surface, and between said surface and said adjusting mechanism, said force sensor measuring an actual force applied by the occupant to said cushion; and
a control unit receiving an actual force value from said force sensor, said control unit also having a predetermined desired force value, said control unit having an automatic mode comparing the actual force value with the desired force value, said control unit controlling said adjusting mechanism to drive the actual pressure value toward the desired force value in said automatic mode.

2. A seat in accordance with claim 1, wherein:
said adjusting mechanism includes a pneumatic bladder;
said force sensor is arranged between said surface of said cushion and a surface of said pneumatic bladder.

3. A seat in accordance with claim 1, further comprising:
a plurality of said adjusting mechanisms being arranged in said cushion, each said adjusting mechanism selectively adjusting a contour and firmness of a different portion of the seat;
a plurality of said force sensors, each of said portions of the seat having one of said plurality of force sensors, said each sensor measuring an actual force applied by the occupant to a respective said portion of the seat;
said control unit controlling each of said adjusting mechanisms to drive an actual force value from a respective said force sensor toward a desired force value for a respective said portion of the seat.

4. A seat in accordance with claim 1, further comprising:
an operator interface receiving input from an operator;
said control unit controlling said adjusting mechanism as a function of the input received by said operator interface in a manual mode, said control unit recording the actual force value from the force sensor when said control unit controls said adjusting mechanism as a function of the input, said control unit setting the desired force value to the actual force value when said control unit controls said adjusting mechanism as a function of the input.

5. A seat in accordance with claim 4, wherein:
said control unit switches between said automatic mode and said manual mode as a function of the input received by said operator interface.

6. A seat in accordance with claim 5, wherein:
said control unit switches from said automatic mode to said manual mode upon receiving input from said operator interface indicating a change in one of shape and firmness of the seat.

7. A seat in accordance with claim 6, wherein:
said control unit switches from said manual mode to said automatic mode upon receiving no input from said operator interface indicating a change in one of shape and firmness of the seat.

8. A seat in accordance with claim 1, wherein:
said adjusting mechanism includes a cable with a tension device adjusting a tension in said cable;
said force sensor is arranged between said surface of said cushion and said cable.

9. A seat in accordance with claim 8, wherein:
said tension device is an electric motor.

10. A seat in accordance with claim 8, wherein:
said tension device is an electric solenoid.

11. A seat in accordance with claim 1, wherein:
said adjusting mechanism includes a spring with a tension device adjusting a tension in said spring;
said force sensor is arranged between said surface of said cushion and said spring.

12. A seat in accordance with claim 11, wherein:
said tension device is an electric motor.

13. A seat in accordance with claim 11, wherein:
said tension device is an electric solenoid.

14. A seat in accordance with claim 1, wherein:
said force sensor is a piezoresistive sensor.

15. A seat in accordance with claim 1, wherein:
said force sensor is one of a resistive, capacitive or inductive sensor.
